(19) United States
(12) Patent Application Publication
(10) Pub. No.: US 2009/0112679 A1
(43) Pub. Date: Apr. 30, 2009

(54) Appointment Scheduling Method and User Interface

(75) Inventor: Geert Machtelinck, Mortsel (BE)

Correspondence Address: HOUSTON ELISEEVA, 4 MILITIA DRIVE, SUITE 4, LEXINGTON, MA, 02421, US

(73) Assignee: QUADRAT, Mortsel (BE)

(21) Appl. No.: 11/817,646

(22) PCT Filed: Feb. 17, 2006
(86) PCT No.: PCT/EP2006/060040

§ 371 Date: Sep. 20, 2007

Related U.S. Application Data
(60) Provisional application No. 60/666,002, filed on Mar. 29, 2005.

(30) Foreign Application Priority Data
Mar. 4, 2005 (EP) 05101684.8
Mar. 4, 2005 (EP) 05101703.6

(51) Int. Cl. G06Q 10/00; G06F 15/16; G06Q 50/00

(52) U.S. Cl. 705/9; 709/204

(57) ABSTRACT

An appointment scheduling method and associated user interface wherein the risk of errors is decreased by displaying in different linked screens identification data of the patient and/or resource to which an action to be performed in the scheduling procedure, pertains.

### FIELD OF THE INVENTION

The present invention relates to an improved appointment scheduling system and associated user interface.

The present invention is in particular applicable in the context of appointment scheduling systems to be applied in medical institutions, where appointments need to be scheduled for patients, taking into account a multitude of constraints such as the availability of personnel and equipment, and of the patient himself.

### BACKGROUND OF THE INVENTION

User profile studies on secretaries scheduling appointments show that one of their biggest fears is to make errors.

Being confronted with a chaotic environment—their help is requested for many patients, many actions in parallel—they are afraid that they would attribute the wrong appointment to the wrong patient name.

Typically, they might be scheduling an appointment for a patient at the front desk, while being interrupted by a phone call and having to enter an appointment for the patient on the phone.

A third line of input can be a physician or colleague secretary, requesting on a note the entry of an appointment on a certain date, for a certain physician/room and for a specific patient.

Similar to this problem, they may schedule the appointment for the correct patient, but in the agenda of the wrong physician.

This can typically happen for a secretary serving multiple physicians and mostly attributing the appointments directly in the resource's agenda.

When again being confronted with several parallel lines of appointment demands, the risk of attributing the appointment to the wrong physician becomes large.

By extension, a physician often switches to the medical file or other result viewing of the active patient. Sometimes, the same patient is put active again, sometimes not. When not being attentive, one may presume the active patient is taken with, while it is not the case. In the latter case, the previous patient is still active in the result viewer and the physician may take the wrong decisions based on a wrong anamnesis.

The hazard of creating an appointment for a patient with a wrong exam could potentially result in dangerous clinical consequences.

The hazard of creating appointments for the wrong resource, typically generates inefficient healthcare.

The hazard of having the wrong medical file at hand could result in clinically wrong decisions.

Current appointment scheduling applications show the identification data of the active patient, being the patient for which an appointment is being made, only in the MDI.

Used objects, such as a specific exam or resource are shown at dedicated places in the graphical user interface (GUI).
The action buttons of creating appointments are icons, sometimes accompanied by a name (OK, Next, etc.)—longest cases would refer to ‘Create appointment’.
One can pass between applications through a shortcut, sometimes taking the active patient with or sometimes having to enter a new patient. This shortcut is mostly an icon, sometimes accompanied by the name of the application.

The prior art systems do not provide a solution to the problems described higher.

It is an aspect of the present invention to provide an improved appointment scheduling system and associated user interface in which the above-described problems are avoided.

### SUMMARY OF THE INVENTION

The above-mentioned advantageous effects are realized by an appointment scheduling method as set out in claim 1.

In this method different linked screens are displayed. In these screens a number of data on client and/or resources can be filled in or selected and displayed. Messages regarding actions pertaining to a client or a resource to be performed with regard to an appointment scheduling procedure are displayed. The actions can be activated by user interaction, for example by checking a check box. According to this invention a displayed message regarding an action is comprises data pertaining to the client or resource to which said action pertains.

The invention provides that the attention of the user is prompted at crucial moments in the procedure to the object onto which an action part of an appointment scheduling procedure is going to be performed.

An object can be a client (being a patient in a medical appointment scheduling system) or a resource. Data pertaining to an object are e.g. names, codes, unique identifiers etc.

In the context of this invention the term ‘resource’ has a broad meaning and, in connection with a medical appointment scheduling system, refers to physical resources such as radiology room, examination equipment such as a CT scanner and also to human resources such as physicians, operators etc.

An example of a scheduling engine for an appointment scheduling system is described extensively in an application entitled ‘Method for processing linked lists of time segments’, filed by the same applicant on the day of filing of the present application.

The embodiments of the methods of the present invention are generally implemented in the form of a computer program product adapted to carry out the method steps of the present invention when run on a computer.

The computer program product is commonly stored in a computer is readable carrier medium such as a CD-ROM. Alternatively the computer program product takes the form of an electric signal and can be communicated to a user through electronic communication.

Another aspect of this invention pertains to an improved user interface for an appointment scheduling system.

The user interface has a number of linked screens in which a user enters and selects data pertaining to a client and/or to resources involved in an appointment scheduling operation. In at least one of the screens a message can be displayed on an action a user of the appointment scheduling system can perform. According to the invention a displayed message pertaining to a client or a resource comprises data identifying said client or resource.

To improve an appointment scheduling system, the invention also provides the ability to retrieve from memory and display a history list of the patient identifiers of the last appointments given.

Specific features for preferred embodiments of the invention are set out in the dependent claims.

Further advantages and embodiments of the present invention will become apparent from the following description and drawing.

### BRIEF DESCRIPTION OF THE DRAWINGS

FIG. 1 to 3 are screen shots pertaining to embodiments of an appointment scheduling system and associated user interface according to the present invention.

FIG. 4 describes a set of actions related to resources and connected by comprising, relational and sequential links;

FIG. 5 describes a reduced set of actions that is left after working out the relational links according to a preferred embodiment;

FIG. 6 describes a reduced set of actions that is left after working out the relational and comprising links according to a preferred embodiment;

FIG. 7 describes a reduced set of actions that is left over after working out the relational, comprising and sequential links according to a preferred embodiment;

FIG. 8 describes a set of time windows associated with actions;

FIG. 9 demonstrates the processing of a relational link according to a preferred embodiment;

FIG. 10 demonstrates the processing of a comprising link according to a preferred embodiment;

FIG. 11 demonstrates the processing of a sequential link with a preceding action according to a preferred embodiment;

FIG. 12 demonstrates the processing of a sequential link with a following action according to a preferred embodiment;

FIG. 13 demonstrates the processing of a sequential link with a following action, taking into account slack time according to a preferred embodiment;

FIG. 14 shows an example of processing a relational link according to a preferred embodiment;

FIG. 15 shows another example of processing a relational link according to a preferred embodiment;

FIG. 16 shows three examples of processing a comprising link according to a preferred embodiment;

FIG. 17 shows an example of the processing of time windows according to a preferred embodiment;

FIG. 18 shows an example of using deductive logic;

FIG. 19 shows an example of using inductive logic;

FIG. 20 shows a data processing system according to a preferred embodiment of the current invention.

### DETAILED DESCRIPTION OF THE INVENTION

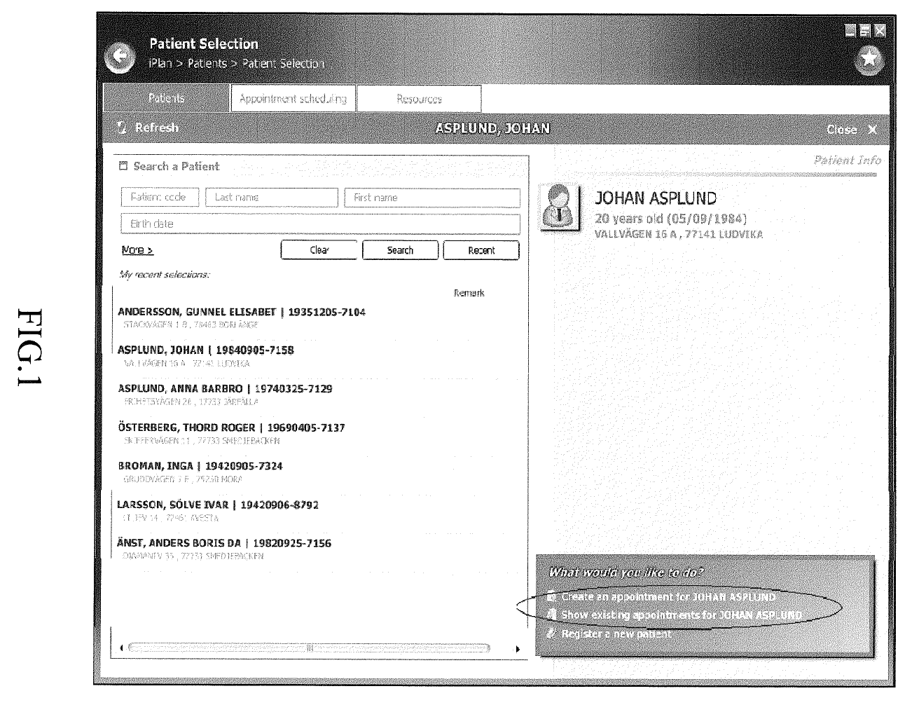

FIG. 1 to 3 show screen prints of the user interface of an appointment scheduling system according to the present invention. The user interface has different tabs relating to different kinds of information regarding the scheduling procedure. The individual tabs are displayed in linked screens. Examples are a screen in which patient identification data can be filled in or selected from a list, an appointment scheduling screen and a screen displaying agendas of different resources such as doctors, examination rooms, examination equipment etc.

Object identifiers, more specifically objects names, such as the names of patients, examinations, doctors etc. are displayed as frequently as possible. They are preferably displayed on places where the user takes the action.

One of the most crucial moments in an appointment scheduling procedure is just after selecting a certain patient.

One can then decide to create an appointment, or to create an order, or maybe to view the medical file of the patient.
In a dedicated action box these actions are displayed and the user can make a selection and start corresponding procedural steps in the scheduling procedure. On locations where such actions are taken it is preferred that the message referring to such an action clearly mentions the object to which the action pertains. Examples are the name of the patient for whom the action will be taken, e.g. “create an appointment for JOHAN ASPLUND” (See FIG. 1).

Similarly, another action could be ‘Show medical history for Patient ASPLUND’. In that way, the user will consciously take the action of viewing the medical history for the particular indicated patient.

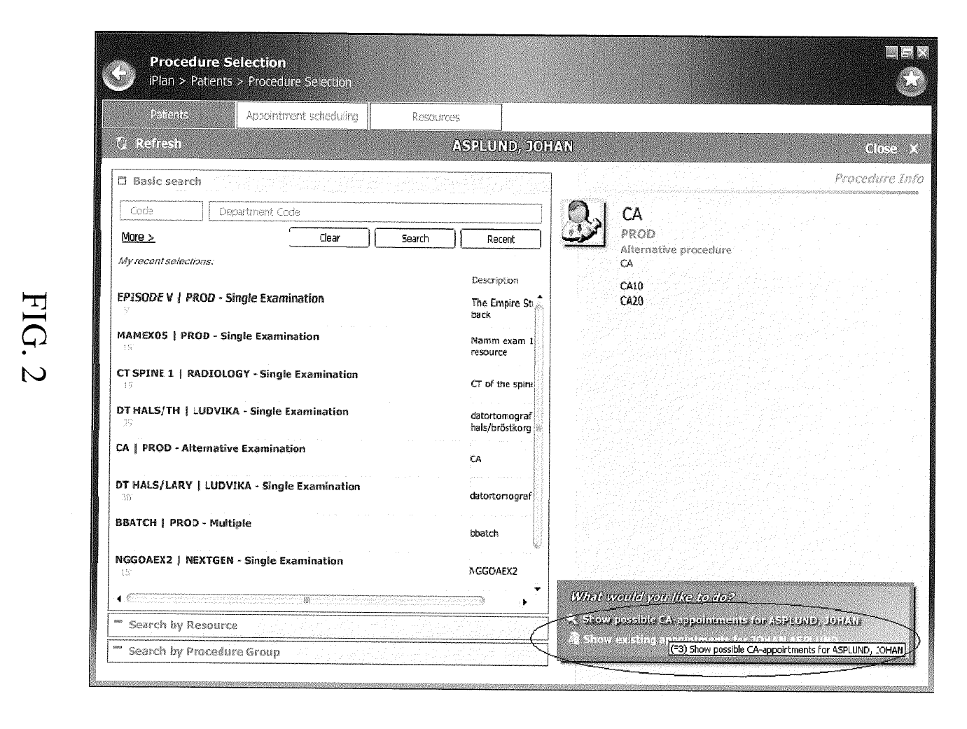

According to another embodiment of this invention when an appointment for a specific patient is created, the crucial action of connecting a certain exam/procedure to a patient is done. The invention provides that in such cases information is given on the specific type of action as well as on the object on which the action is performed. Messages of the following type are then generated in a action box: ‘Show possible ‘Exam code’ appointments for Patient X’. In FIG. 2 the following example is the shown: “Show possible CA-appointment for ASPLUND, JOHAN”. Notice that even within tool-tips on actions, the specific objects at stake are indicated, namely:
the specific code of a procedure
the patient's full name

The example of FIG. 2 shows how a resource object can repeatedly be indicated. This is crucial for a secretary managing multiple resources.

By repeating the specific object identifiers throughout the workflows through action & confirmation buttons or links, risk of medical errors is reduced.

Similarly, when booking directly into the agenda of a resource, the resource's code or name can be indicated, as is shown in FIG. 3.

The invention is based on the underlying appointment scheduling procedure in which every link has access to the application model, describing the current state of the application (e.g. selected patient, procedure, resource, etc). It can use any type of information within the model to describe itself.

With any modification of the model, the links can track these changes and update themselves accordingly (e.g. change the presented string presented in the user interface).

Another aspect of this invention relates to the displaying and referencing of frequently used patient identifications (ID's) as described below.

Market investigation has shown that a big problem consists in building up and maintaining a patient ID database, where patients can easily and correctly be identified.
When a patient phones to a hospital or presents himself at the front desk, he often cannot give a unique identifier and this is also not present in the database.
However, if the patient already presented himself in an earlier stage to the hospital, it is important for the appointment scheduler to retrieve the correct patient ID from the database, in order to build up a complete and correct medical file without gaps in previous appointments.
Similarly, in case of hospitalised patients receiving several appointments, it is important that each time the same patient ID receives the appointments. In practical situations, the appointment scheduler doesn't always have a unique ID at hand to retrieve the specific patient from the database.

So in order to find back the patient in a practical way, the appointment scheduler has to rely on side information, typically name, first name, date of birth, address.

In many ways, this side information can be corrupted (and is difficult to avoid):
errors are made when the information is being stored in the system, typically typing errors
a lot of persons do not have an exact spelling of their names (typically persons whose written language is not in western characters)
in Arabic culture, only a year of birth is known, these persons are attributed the first of January as day and month of birth, consequentially making a patient search becomes difficult
address is subjected to change

As a result, the appointment scheduler is often confronted with the situation that 2 or 3 patient ID's retrieved are indeed quite similar, but only one is the correct patient ID. This combined with a stressful environment, often the wrong choice of patient could be made.

This could result in the fact that when that particular patient is being treated (e.g. in a consultation), a physician can be confronted with a wrong anamnesis in his medical file.

An embodiment of the appointment scheduling system of the present invention provides a solution to this problem for the cases where patients:
receive regularly appointments, e.g. in case of hospitalised patients and patients undergoing therapy
call back to modify their existing appointment(s) in some way

In this embodiment the exact patient identifiers of the last appointments given are stored and displayed. This is typically done in the patient selection list as illustrated in FIG. 1.

In case of hospitalised patients, these data could be retrieved from this list, on the condition that already one appointment was made. It assures that consecutive appointments will be attributed to the same patient ID.

In case of a patient phoning back to modify a specific appointment, the patient could also be retrieved from this list. This modification can be a deleting or rescheduling of one of his appointments, but it could also be an extra administrative or clinical information.

The appointment scheduling system is designed so that all objects that can be selected and with which a certain action is performed, are queued in a history list, which is stored on the server for each individual user. During start up of the application, the history lists are retrieved from the server and made available to the user. Below aspects of the underlying scheduling method, more specifically of the method of generating a solution space, are described extensively.

Before explaining the general principles of the scheduling method, the method is first explained by working out a specific example, which is also one specific embodiment of the current invention.

According to the example, an appointment needs to be scheduled to examine a patient by means of a scanner. The patient needs to undress before and to dress again after the scan.

The exam itself takes 2 hours. Both for undressing and dressing one hour is provided. After the patient has undressed, he does not want to wait for the exam. When the exam is finished, he accepts that he may have to wait up to one hour before he can dress again.

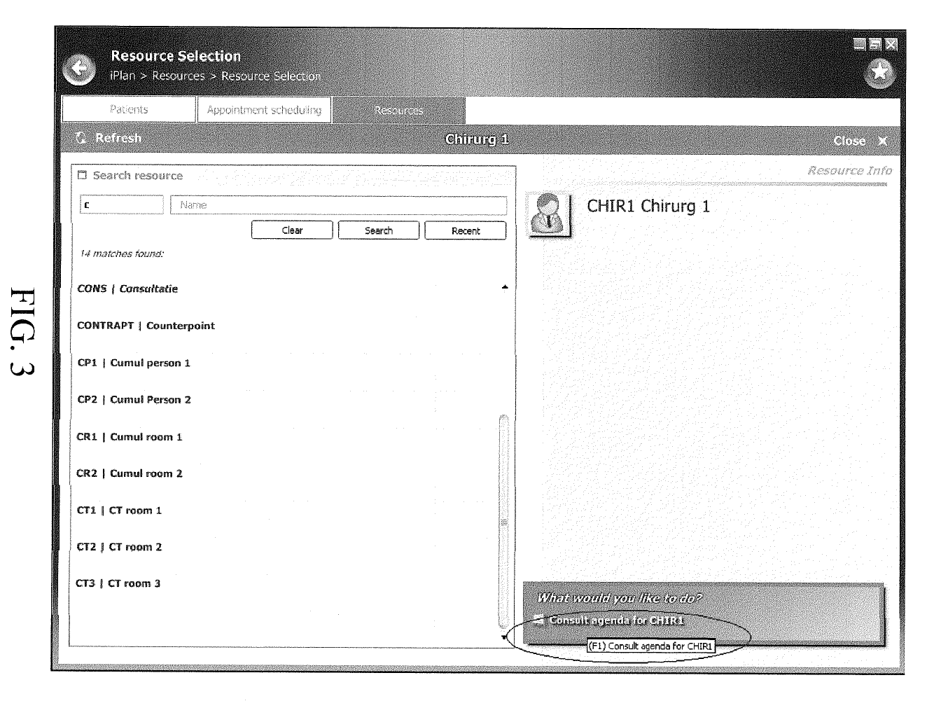

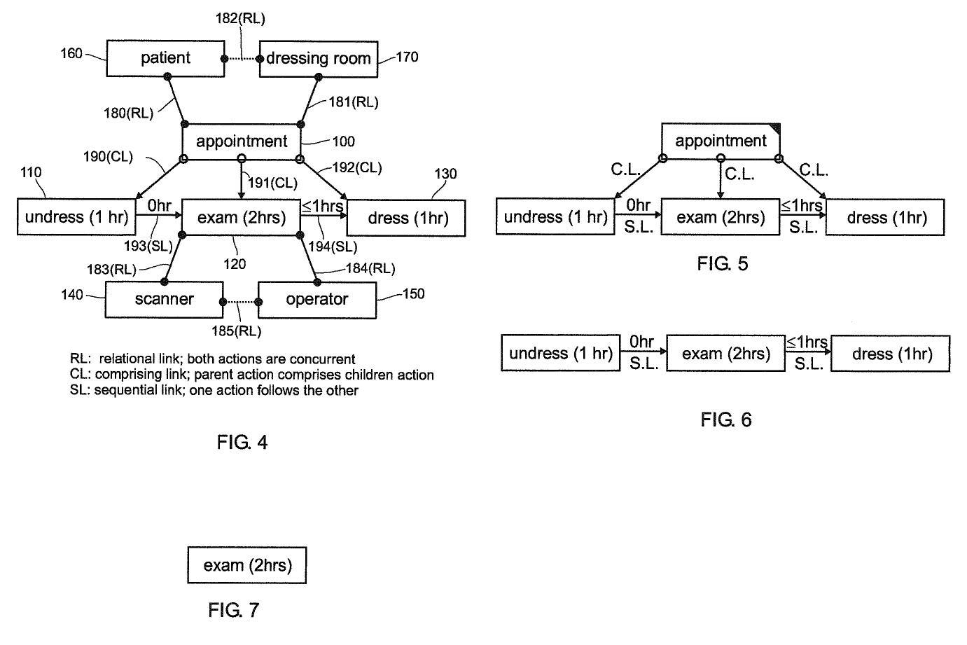

FIG. 4 describes the actions that are part of the appointment and the relations between them. The appointment (100) action comprises three other actions: the undressing (110) action, the actual exam (120) action and the dressing (130) action. This comprising relationship is represented by three comprising links (190, 191, 192) between the individual actions (110, 120, 130) and the appointment (100) action. The appointment (100) action is called a parent relative to the undressing (110), the actual exam (120) and dressing (130) actions which are called children. Because of the parent-child relationship of a comprising link (190, 191, 192), it is not symmetrical.

An action is defined as being “atomic” when it does not comprise other actions. For example, the undress (110) action is atomic, but the appointment (100) action is not.

The undressing (110), the actual exam (120) and dressing (130) actions follow sequentially and this relationship is represented by the sequential links (193, 194). The sequential nature implies that such a link is not symmetrical, as the arrows in FIG. 4 also indicate.

The exam (120) can only be carried out when the scanner (140) is available. This kind of relationship is represented by a relational link (183). In addition does carrying out the exam require the availability of an operator, so a relational link (184) also exists between the exam and the operator (150). A relational link between two actions indicates that both actions can only be carried out at the same time. From this follows that such a link is by nature symmetrical and transitive. The transitivity is expressed in FIG. 4 by the dotted line (185) between the scanner and operator action.

In a more general case, a procedure or exam is preceded by a pre-op action and followed by a post-op action. In a more general case an action refers to an activity related to a resource. Such a resource can be a patient, a physician, a nurse, an operator a diagnostic or treatment apparatus, a examination or treatment room, or any other kind of resource with which an activity can be associated. The resource can or can not be related to the domain of healthcare. The activity can be the use of equipment, the presence of a person, the occupation of a facility or any other activity that refers to the use or availability of any resource. In a more general case any topology of any number of actions related by comprising, relational or sequential links is possible.

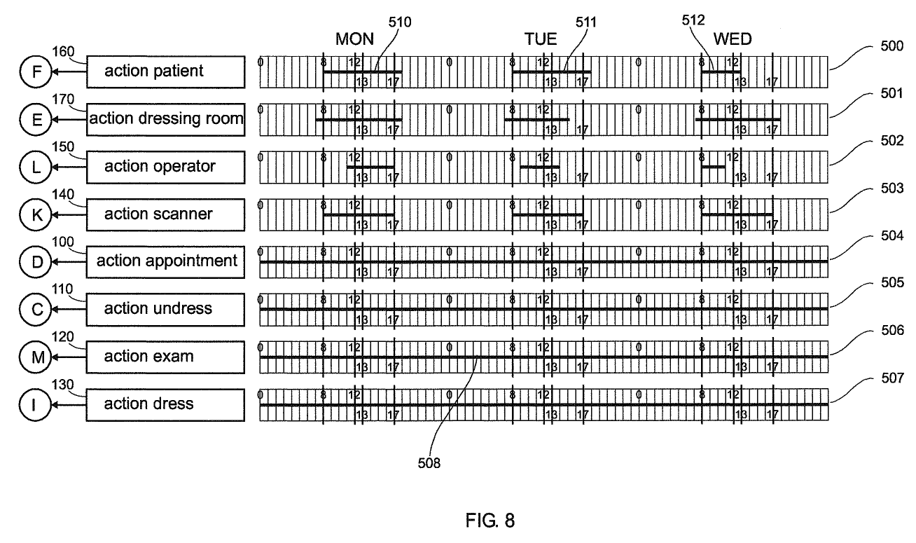

FIG. 8 shows how with each action (100, 110, 120, 130, 140, 150, 160, 170) in FIG. 4 a corresponding time window (501-507) is associated. A time window consists of a linked list of non contiguous time segments, each segment having a beginning and an ending time. For example, for the patient (160) action, the linked list consists of the time segments (510, 511, 512).

A time window can represent the range of time when an action can potentially occur. However, a time window can also represent a range of time when the action can start or when it can end.

In the example in FIG. 8, the time windows (500-503) of the patient (150), the dressing room (170), the scanner (140) and the operator (150) are part of the problem definition data. These time windows represent constraints imposed by the corresponding resources. The time windows (504-507) of the undressing (110), exam (120) and dressing (130) actions and of the appointment (100) as a whole, however, are initially undetermined, as they are the subject of the solution that has to be calculated for the scheduling problem. An undetermined time window is represented as one contiguous time segment with the length of the time window. For example, 508 is the initial time window associated with the exam action (120). As a solution for the time scheduling problem is being processed according to the current invention, the number of segments of an undetermined time window may change and the beginning and end times of the remaining time segments may become increasingly more focused, until they represent a situation that is consistent with all the constraints imposed by the resources.

Since the constraints imposed by the resources are represented by relational (180-185), comprising (190-192) and sequential (193, 194) links, processing the solution essentially comes down to working out these links.

When working out the links, a number of different cases are to be distinguished that correspond with the different nature of the links (relational, comprising or sequential), the interpretation of the time window of the action (start times, end times or action times), and the relative location of the time segments (the way that the time segments in the time windows of the linked actions overlap). The result of processing a link involves adjusting the time segments in the time windows corresponding to the linked actions in a way that they become consistent with the constraints imposed by the corresponding resources.

In the following paragraphs the processing of the different links is discussed.

First Case: Time Window Processing for Actions Connected Through Relational Links

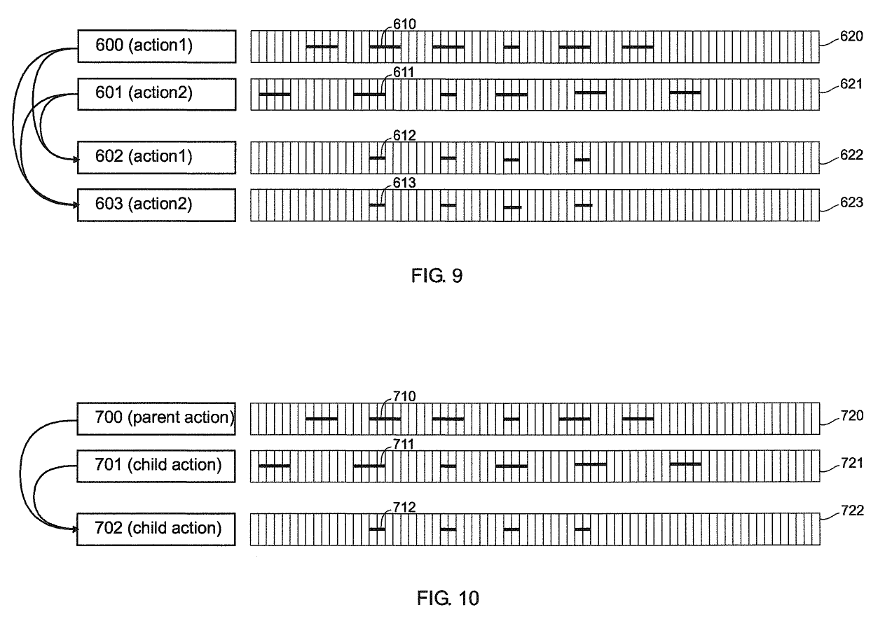

FIG. 9 illustrates a number of situations for actions connected through relational links, of which the time segments occur in different relative positions (overlapping and non-overlapping). The interpretation of the time windows (620-623) is that the represent the time during which the action (600-603) can take place. Since the meaning of a relational link is that the two actions (600,601) can only take place simultaneously, the effect of working out the link is that each time window (620,621) should be replaced by a time window (622,623) that consists of time segments (612,613) that are the cross sections of the time segments (610,611) in the original time windows.

Because of the transitive nature of a relational link, if an action has more than one relational link—directly or indirectly—to another action, the time windows of all the actions are to be replaced by a time window of which the time segments are the cross sections of all the time segments of the time windows of all the related actions.

Second Case: Time Window Processing for Actions Connected Through Comprising Links

FIG. 10 illustrates a number of situations for actions connected through comprising links, of which the time segments occur in different relative positions (overlapping and non-overlapping). The interpretation of the time windows (700-702) is that the represent the time during which the action can take place. The meaning of a comprising link is that the time segments (711) of a child action (701) have to occur within the time segments (710) of the time window (720) of the parent action (700). This is achieved by replacing the time segments (711) of the time window (721) of the child action (701) by the cross section (712) of themselves (711) with the time segments (710) of the time window (720) of the parent action (700).

Third Case: Time Window Processing for Actions Connected Through Sequential Links

The following terms are introduced or clarified:
time window of an action: linked list of time segments describing when an action can take place.
time window of start times of an action: linked list of time segments describing when said action can start;
time window of end times of an action: linked list of time segments describing when said action can end;

The time window of an action, the time window of start times of the same action and the time window of end times of that same action are interrelated.

Referring to FIG. 12 and according to an embodiment of the current invention, a time window (921) representing start times (911) of an action is calculated from a corresponding time window (920) representing said action, by subtracting from the end times of the time segments (910) in the latter time window (920) the duration (930) of said action.

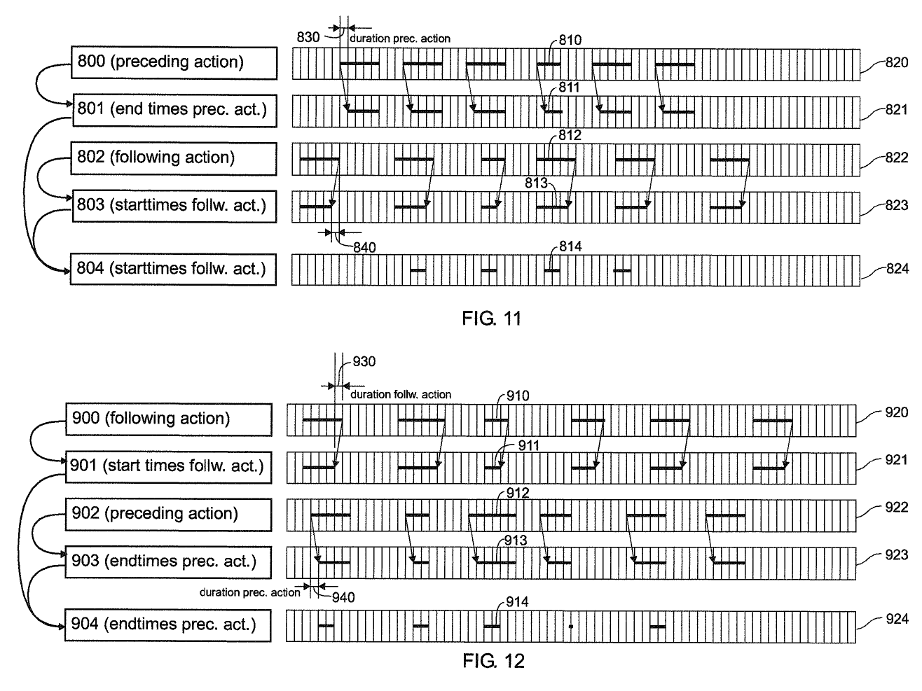

Referring to FIG. 11 and according to an embodiment of the current invention, a time window (821) representing end times is of an action is calculated from a corresponding time window (820) representing said action, by adding to the start times of the time segments (810) in the latter time window (820) the duration (830) of the action.

According to an embodiment of the current invention time windows representing start times and end times of an action are also interrelated by shifting the start and end times in the time segments by the duration of the action.

According to one embodiment of the current invention, when a first preceding action (800, 902) is followed by a second following action (802, 900), certain restrictions are applied on both the start and end times of both actions.

A first restriction involves the start times of a following action in order to achieve that that the start times of a following action can never be earlier than the earliest end time of any of the preceding actions. According to one aspect of the current invention, this effect is achieved by replacing the time segments (813) of the start times (823) of the following action (802) by the cross section (814) between themselves (813) and the time segments (811) of the end times (821) of the preceding action (800).

A second restriction involves the end times of the preceding action in order to achieve that the end times of a preceding action can never be later than the latest start times of any of the following actions. According to one aspect of the current invention, this effect is achieved by replacing the time segments (913) of the end times (923) of the preceding action (902) by a cross section (914) between themselves (913) and the time segments (911) of the start times (921) of the following action (900).

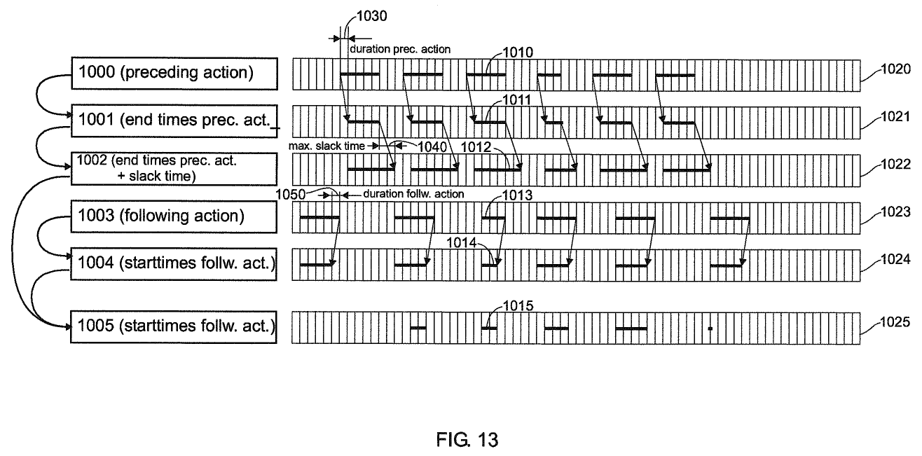

In the case that slack time is allowed between two actions, the end times of the time segments of the preceding action are preferably extended by the maximum allowed slack time, prior to applying said first restriction. Referring to FIG. 13, the time window (1020) of the preceding action (1000) is used to calculate the time window (1021) of the end times (1001) of the preceding action (1000) by shifting the start times of the time segments (1010) forward by the duration (1030) of the preceding action (1000). Following that, the segments (1011) of the time window (1021) of the end times (1001) of the preceding action are extended by the maximum slack time (1040) to yield the time segments (1012) of the time window (1022) of the end times (1002) of the preceding action plus the slack time. To obtain the time window (1024) of the start times of the following action (1004), the end times of the segments (1013) of the time window (1023) of the following action (1003) are shifted backwards by the duration (1050) of the following action (1003). The segments (1015) of the time window (1025) of the start times of the following action (1005) are obtained by making the cross section between the time segments (1012) and the time segments (1014).

Working out a sequential link between two actions involves applying the two above restrictions.

Having described how according to the current invention:
relational links are processed(l);
composite links are processed (2);
the relation between time windows representing actions, start times and end times (3) is processed;
sequential links are processed (4);
slack time is processed in sequential links (5).

we proceed next by working out the example that was earlier introduced according to the principles of the current invention.

The problem that has to be resolved is finding the time window representing the start time(s) for the exam.

A first step consists of working out the relational links in FIG. 4.

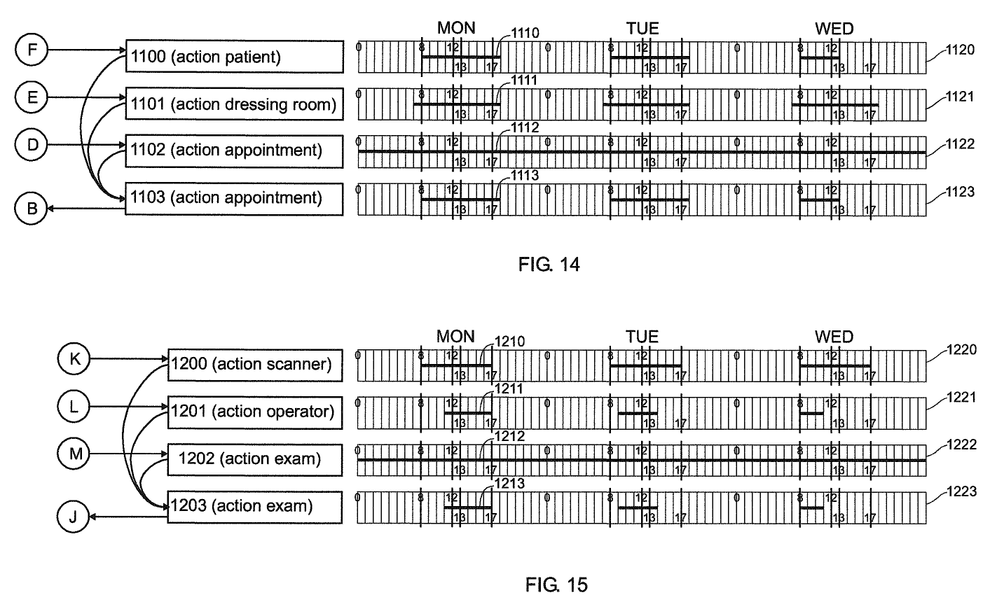

Referring to FIG. 14, this is done by using the general principles according to the current invention that were earlier explained by means of FIG. 9.

Similarly, referring to FIG. 15, the relational links can be worked out between the exam, the operator and the scanner.

After this operation, the graph in FIG. 4 can be reduced to the one in FIG. 5, with the notion that he time windows associated with the appointment and the exam actions are not the original ones, but the ones that were obtained from the previous step.

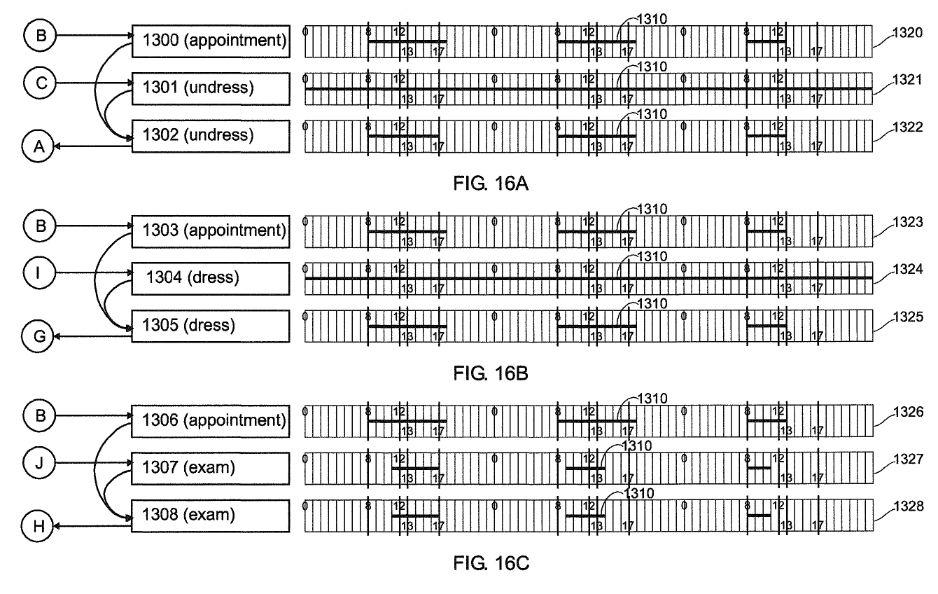

A second step consists of working out the comprising links in the graph in FIG. 5. According to the current invention, this is achieved by processing the time segments in the time windows of the undress, exam and dress actions so that they fall within the time segments of the time window of the appointment action. This is demonstrated in FIGS. 16A, 16B and 16C using the general principles of the current invention that were earlier explained by means of FIG. 10.

After this operation, the graph in FIG. 4 or FIG. 5 can be reduced to the one in FIG. 6, with the notion that he time windows associated with the undress, exam and dress actions are not the original ones, but the ones that were obtained from the previous step.

The third step consists of working out the constraints imposed by the sequential links.

The exam action is preceded and followed by another action. According to one aspect of the current invention, this has implications on start and end times of the time segments of the corresponding time windows.

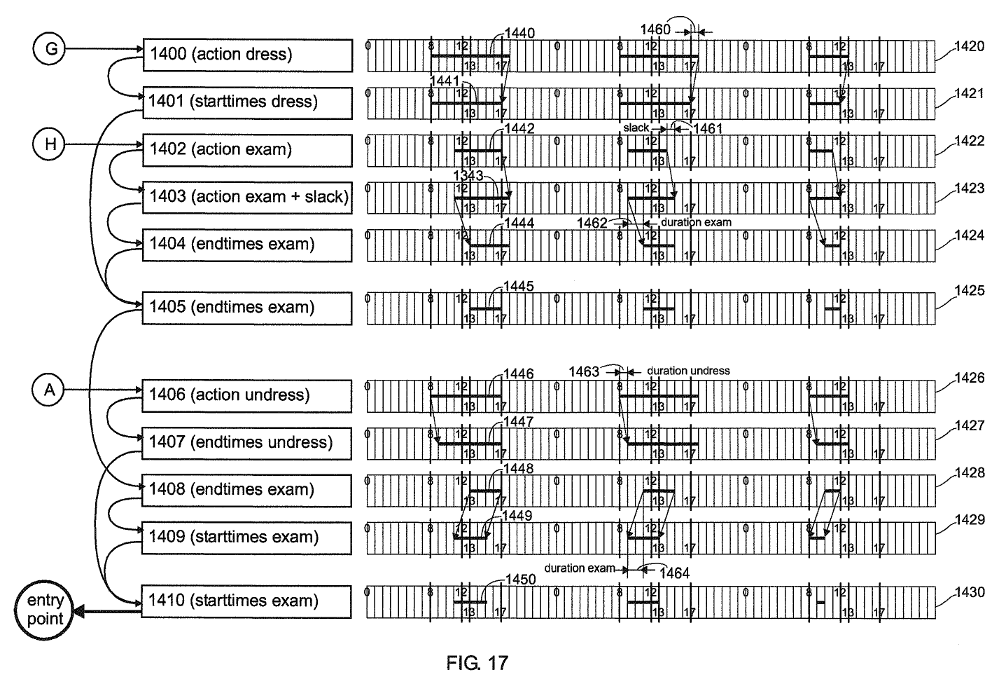

Referring to FIG. 17, the start times (1310) of the exam should never be earlier than the earliest end times (1307) of the undress action, and the end times (1303) of the exam including slack time should never be later than the latest start times (1301) of the dressing action, according to the general principles that were earlier explained by means of FIGS. 11, 12 and 13.

After this operation, the graph in FIGS. 4, 5 and 6 can be reduced to the one in FIG. 7, with the notion that he time window associated with the exam actions are the ones that were obtained from the previous step.

Introducing Deductive and Inductive Logic

According to a preferred embodiment of the current invention, an inductive logic method is used to control the processing of the time windows as opposed to deductive logic. These terms are explained in more detail.

Generally speaking, deductive logic starts with variables of which the values are known (called “the hypotheses”) and deduces step by step according to a predefined flow the value of the variable for which a solution is sought (called the “final conclusion”). This processing occurs through the calculation of the value of intermediate values (called “intermediate conclusions”).

In deductive logic, the information processing flow itself is the subject of the programming and as a result, once it has been programmed, it is fixed. Therefore, deductive logic programming is efficient for those problems of which the taxonomy of relations between variables is fixed, and only the values of the hypotheses are subject to change.

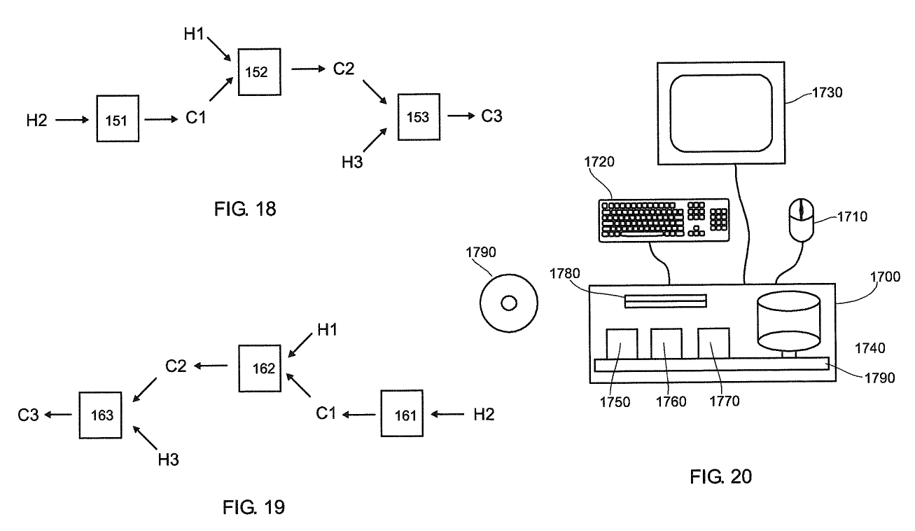

An example of a deductive logic method is shown in FIG. 18. H1, H2 and H3 are the basic hypotheses. Processing (151) the hypothesis H2 results in the intermediate conclusion C2. Processing (152) the conclusion C1 and the hypothesis H1 results in the intermediate conclusion C2. Processing (153) the conclusion C2 and the hypothesis H3 then leads to the final conclusion C3.

In contrary, the entry point for an inductive logic method according to the current invention is the final conclusion itself of which the value is initially unknown. By means of a set of inductive steps that take the form of an exploration process, the data of the hypotheses is first gathered and then systematically processed to calculate the final conclusion.

An inductive step to calculate an (intermediate) conclusion comprises determining what other variables are needed to calculate said (intermediate) conclusion. There are two possibilities:

1) Either the values of the variables that are needed are known because they are either hypotheses or intermediate conclusions of which the value has been earlier determined; in that case the variables can be processed to obtain the (intermediate) conclusion.

2) Or at least one of the variables that are needed is an intermediate conclusion of which the value has not been determined yet; in that case this (intermediate) conclusion initiates a new inductive step.

The subject of the programming in an inductive logic method is not a deductive information processing flow, but a rule set that manages the inductive steps.

Developing a rule set for an inductive method involves determining:

1) the nature (classes) of the variables (intermediate conclusions) that are needed to calculate a conclusion;

2) for each nature (class) of a variable (intermediate conclusion) determining what kind of processing on what other variables (other intermediate conclusions or hypotheses) is needed to calculate the result of said (intermediate) conclusion.

Unlike in a deductive logic method, the problem definition now not only states the values of the hypothesis, but also the taxonomy of the relations between the variables. This allows for far greater flexibility when solving problems that have different taxonomies of relations between variables. Once the rule set has been programmed, problems with a wide variety of taxonomies of relations between the above variables can be solved using the same program.

An example of using an inductive logic method is presented in FIG. 19. The entry point is a call to calculate the value of the variable C3. The rule set dictates that the variable C3 requires the processing of two other variables being H3, of which the value is known since it is a hypothesis, and the intermediate conclusion C2, of which the value at this point is unknown. The latter causes a new inductive step to calculate the unknown variable C2. The rule set dictates that the variable C2 requires the processing of two other variables H1, of which the value is known since it is a hypothesis, and of the intermediate conclusion C1, of which the value at this point is unknown. The latter causes a new inductive step to calculate C1. The rule set dictates that the variable C1 requires the processing of the variable H2, of which the value is known. This results in the processing of H2 to obtain C1. Now that C1 is known, this results in the processing of C1 and H1 to calculate C2. Now that C2 is known, this results in the processing of C2 and H3 to calculate the final conclusion C3.

Preferred Embodiment Based on Inductive Logic

According to the current invention, the solution of the scheduling problem stated in the above example is preferably carried out by using an inductive logic method.

According to one embodiment, the following classes or variables are used for managing resources:
time window related to an action
time window related to the start times of an action
time window related to the end times of an action

According to the same embodiment the inductive logic is managed by a set of three rules:
a first rule dictates that obtaining the value of a variable of the type “start times of an action” requires the processing of the value of the “end times of that action” and the value of “the previous action”.
a second rule dictates that obtaining the value of a variable of the type “action” requires the processing of the values of the “parent actions” and the “related actions”.
a third rule dictates that obtaining the value of a variable of the type “end times of an action” requires the processing of that same “action”, the “slack time” and “the following action”.

In a more general case other sets of rules can be selected that however yield equivalent results and also fall within the scope of the current invention. This follows from the fact that the classes of variables in the above rule set are related to each other by simple relationships.

We have found that the above set of three classes of variables in combination with the above three rules provides a self contained method than enables resource scheduling and management of a wide variety of situations.

The method according to the current invention processes time windows and results in a time window that generally comprises a plurality of time segments, each one indicating a single solution of when the corresponding action can take place (or start). The method hence produces not just one solution for the scheduling problem, as in the prior art, but a complete set of solutions also called a solution space.

The method according to the current invention can be used for any resource scheduling and management problem that can be modelled as a set of actions corresponding to resources that are related by a combination of comprising, relating and sequential links and slack time.

Having described the general principles of the current invention we proceed by working out the example that was earlier introduced.

Referring to FIG. 17, the method starts by instantiating a variable start times exam, which is the final conclusion of the scheduling problem.

The symbols in the circles on one of the FIG. 14 to 17 indicate references to the same symbols in circles in one of the other figures.

Since the value of the variable start times exam at this point is unknown, this induces an inductive step (IS1). The first rule according to the current invention dictates that in order to calculate the value (1410) of the start times of the exam, the values (1408=1405) of the end time of the exam action and (1406=1302) of the undress action are needed. Since none of these values are known at this time, this causes two new inductive steps: a first one (IS2) to enable the calculation of the value (1406=1302) of the undress action and a second one (IS3) for the calculation of the value (1408=1405) of the end times of the exam.

We proceed by first explaining the inductive step (IS2). Referring to FIG. 14 to 17, the second rule dictates that in order to calculate the value (1406=1302) of the undress action requires the processing of the value (1300=1103) of the appointment action which is the parent action. Since the value (1300=1103) of the appointment action is not known at this time, this induces again an inductive step (IS4) for the calculation of that variable. Since this variable (1300=1103) appointment is of the type “action”, the same (second) rule applies, requiring the processing of the values of related dressing room (1101) and patient (1100) actions. The values of these actions are known since they are hypotheses, so this enables to calculate the value of the appointment (1300=1103) action and subsequently of the undress (1406=1302) action.

We next proceed by describing the inductive step (IS3). Referring to FIG. 14 to 17, the third rule dictates that the calculation of the value (1408=1405) of the end times of the exam requires the processing of the value (1402=1308) of the exam action and of the value (1400=1305) of the dress action. Since the variable (1402=1308) of the exam action is of the type “action”, the second rule applies, and this requires the processing of the values of the parent appointment (1306=1103) action, and of the related scanner (1200) and operator (1201) actions. The value (1306=1103) of the parent appointment action is calculated the same way as in the inductive step (IS2). The values (1200, 1201) of the relating actions are known, since they are hypotheses, so this enables to calculate the value of the exam (1402=1308) action. Since the variable (1400=1305) is also of the type action, the second rule is applied once more, leading to the processing of the values of the variables (1303=1103) and (1304=1101). At this point the calculation of the value (1408=1405) of the end times of the exam can be completed and subsequently the calculation of the value (1410) of the start times of the exam.

The above mentioned invention is preferably implemented using a data processing system such as a computer. An embodiment of such a system (1700) is shown in FIG. 20. A computer comprises a network connection means (1750, a central processing unit (1760) and memory means (1770) which are all connected through a computer bus (1790). The computer typically also has a computer human interface for inputting data (1710, 1720) and a computer human interface for outputting data (1730). According to one embodiment, the computer program code is stored on a computer readable medium such as a mass storage device (1740) or a portable data carrier (1790) which is read by means of a portable data carrier reading means (1780).

Having described in detail preferred embodiments of the current invention, it will now be apparent to those skilled in the art that numerous modifications can be made therein without departing from the scope of the invention as defined in the appending claims.

1. An appointment scheduling system wherein in different linked screens on a display device data on a client and/or a resource can be filled-in or selected and displayed and wherein on top of at least one of said screens a window is displayed comprising at least one message on an action pertaining to a client or a resource to be performed with regard to a step of an appointment scheduling procedure and wherein means are provided for confirming said message before a next step of said appointment scheduling procedure can be performed.

2-4. (canceled)

5. A system according to claim 1 wherein said message pertaining to an action comprises data pertaining to the client or resource to which said action relates.

6. A system according to claim 1 wherein by default or upon command a history of patient identifiers is retrieved from memory and displayed.

7. A user interface for an appointment scheduling system, comprising:
a number of linked screens displayed on a display device in which a user enters and selects data pertaining to a client and/or to resources involved in an appointment scheduling procedure; and
at least one window displayed superposed on at least one of said screens, said window comprising at least one message on an action pertaining to a client or a resource to be performed with regard to a step of an appointment scheduling procedure;
means for confirming said message by user interaction, said means being arranged so that a next step of an appointment scheduling procedure can only be performed after confirmation.

8. A user interface according to claim 7 wherein said displayed message comprises data pertaining to a client or resource to which said action relates.

9. A user interface according to claim 7, further comprising means which are arranged for retrieving from memory a history of patient identifiers upon activation by a user.

10. An appointment scheduling method, comprising:
displaying a number of linked screens on a display device;
enabling user entry and selection of data pertaining to a client and/or to resources involved in an appointment scheduling procedure;
displaying at least one window superposed on at least one of said screens, said window comprising at least one message on an action pertaining to a client or a resource to be performed with regard to a step of an appointment scheduling procedure; and
only allowing a next step of an appointment scheduling procedure to be performed after confirmation of said message by a user.

11. A method as claimed in claim 10, wherein said displayed message comprises data pertaining to a client or resource to which said action relates.

12. A method as claimed in claim 10, further comprising retrieving from memory a history of patient identifiers upon activation by a user.
